(19) United States
(12) Patent Application Publication
(10) Pub. No.: US 2012/0097057 A1
(43) Pub. Date: Apr. 26, 2012

(54) PRINTING UNIT AND A PRINTING PRESS AND PRINTING ROLLER OR IMPRESSION CYLINDER OF A PRINTING PRESS

(75) Inventors: Martin ENDISCH, Wertingen (DE); Peter Knauer, Muenster/Lech (DE); Josef Singler, Binswangen (DE); Arthur Meitinger, Zusmarshausen (DE)

(73) Assignee: manroland AG, Offenbach/Main (DE)

(21) Appl. No.: 12/910,606

(22) Filed: Oct. 22, 2010

(51) Int. Cl. B41F 5/00; B41F 13/10

(52) U.S. Cl. 101/216; 101/375

(57) ABSTRACT

A printing unit of a printing press and a printing roller or an impression cylinder of a printing press is disclosed. The printing roller or the impression cylinder has a first and a second base element (1, 2) and a hollow cylinder (3) made of a fiber-reinforced material.

### BACKGROUND AND SUMMARY OF THE INVENTION

The present invention relates to a printing unit of a printing press and to a printing roller or an impression cylinder of a printing press.

Printing presses as well as printing rollers or impression cylinders of a printing press are sufficiently known in principle.

The object of the present invention is improving already known printing units of a printing press and printing rollers or impression cylinders for printing presses. This object is attained by the characteristics of the independent claims.

The invention relates to a printing roller or an impression cylinder of a printing press, comprising:
a first and a second base element, and
a first hollow cylinder arranged between the first and second base element and made of a fiber-reinforced material, for example a glass-fiber-reinforced material like glass-fiber-reinforced plastic or a carbon-fiber-reinforced material like carbon-fiber-reinforced plastic,
wherein the base elements are made of a solid, metallic material,
wherein the first hollow cylinder made of a fiber-reinforced material extends at least in a first partial region of the base elements beyond the base elements,
wherein, during printing operation, a functional layer is arranged or can be arranged above the first hollow cylinder made of a fiber-reinforced material, and
wherein the printing roller or the impression cylinder is designed for a functional layer having a useable width corresponding to the length of 8 or 9 A4 printed pages or the width of 12 or 13 A4 printed pages.

Therefore especially, a simple design of the printing roller or of the impression cylinder is ensured. In addition, the printing roller or the impression cylinder may be designed in terms of its mass and natural frequency in such a way that the natural frequency is considerably above the rotational frequency of the printing roller or of the impression cylinder when the printing press is being operated so that interfering vibrations during printing press operation can be avoided due to a resonance of the natural frequency of the printing roller or of the impression cylinder with the rotational frequency of the printing roller or the impression cylinder. Furthermore, because of the above-mentioned structural characteristics, a stable connection of the individual elements is possible. Finally, the above-mentioned characteristics make it possible to provide a printing roller or an impression cylinder or a printing press with greater production volumes with a useable width corresponding to the length or width of 12 or 13 A4 printed pages, wherein, despite this, it is possible to operate the printing roller or the impression cylinder or the printing press in a manner that is stable and low in vibrations.

The format of a DIN-A4 printed page (also abbreviated as A4) is a standard size for a paper format which was specified in Germany by the German Institute for Standardization (DIN) in DIN-Standard DIN-476. The German standard served as the basis for the European or international equivalent EN ISO 216, which has, in turn, been adopted in almost all countries. The A4 format corresponds to a page width of 210 millimeters (mm) and a page height (=length) of 297 mm.

It may be provided in the case of the printing roller or the impression cylinder that an intermediate layer is arranged above the first hollow cylinder made of a fiber-reinforced material, said intermediate layer being made of a different material than the functional layer and the first hollow cylinder made of a fiber-reinforced material.

It may be provided in the case of the printing roller or the impression cylinder that the intermediate layer contains dyes, which give the intermediate layer a different color than that of the functional layer arranged above it or to be arranged above it. If the functional layer has to be removed for further use of the printing roller or of the impression cylinder, then it is easy for one to identify on the basis of the different color whether the functional layer has been removed completely. If removal of the functional layer is carried out, for example, with material-removing tools like a lathe, then one is easily able to identify from the emerging different color when a complete removal of the functional layer has occurred so that the process of material removal can be terminated. At the same time, the intermediate layer prevents the tools from damaging the fiber-reinforced hollow cylinder arranged beneath it.

It may be provided in the case of the printing roller or the impression cylinder that the functional layer and/or the intermediate layer have a larger width than the first hollow cylinder made of a fiber-reinforced material. Therefore, any joint that may be present between the first hollow cylinder and the base elements may be covered in particular and thereby be protected from external influences so that, for example, the penetration of water or ink into the joint may be prevented.

It may therefore be provided in the case of the printing roller or the impression cylinder that the functional layer and/or the intermediate layer extend beyond the first hollow cylinder made of a fiber-reinforced material also at least partially beyond the base elements.

The invention also relates to a printing roller or impression cylinder of a printing press, comprising:
a first and a second base element, and
a first hollow cylinder made of a fiber-reinforced material arranged between the first and the second base element,
wherein the base elements are made of a solid material,
wherein the first hollow cylinder made of a fiber-reinforced material extends at least in a first partial region of the base elements beyond the base elements,
wherein an intermediate layer is arranged above the first hollow cylinder made of a fiber-reinforced material, said intermediate layer being made of a different material than the functional layer and the first hollow cylinder made of a fiber-reinforced material,
wherein during printing operation the functional layer is arranged or can be arranged above the intermediate layer, and
wherein the functional layer and/or the intermediate layer have a larger width than the first hollow cylinder made of a fiber-reinforced material.

The invention also relates to a printing roller or impression cylinder of a printing press, comprising:
a first and second base element, and
a first hollow cylinder made of a fiber-reinforced material arranged between the first and the second base element,
wherein the first hollow cylinder made of a fiber-reinforced material extends at least in a first partial region of the base elements beyond the base elements,
wherein an intermediate layer is arranged above the first hollow cylinder made of a fiber-reinforced material, said intermediate layer being made of a different material than the first hollow cylinder made of a fiber-reinforced material, or, during printing operation, a functional layer is arranged or can be arranged above the first hollow cylinder made of a fiber-reinforced material, said functional layer being made of a different material than the first hollow cylinder made of a fiber-reinforced material,
wherein the functional layer and/or the intermediate layer have a larger width than the first hollow cylinder made of a fiber-reinforced material, and
wherein the base elements are made at least partially of a material whose coefficient of thermal expansion corresponds to the coefficient of thermal expansion of the first hollow cylinder made of a fiber-reinforced material.

It may be provided, in the case of the printing roller or the impression cylinder, that the base elements are made at least partially of a metallic material which has a coefficient of thermal expansion α less than 10*10⁻⁶ K⁻¹, in particular a coefficient of thermal expansion α less than 5*10⁻⁶ K⁻¹, in addition, in particular, a coefficient of thermal expansion α less than 2.5*10⁻⁶ K⁻¹. In this case, in particular, a metallic material made of a metal alloy with a nickel percentage between 30% and 40% may be used. Especially applicable in this case are iron-nickel alloys, which might also include cobalt as another element, but this is not absolutely necessary. FIG. 7 depicts the coefficient of thermal expansion α of an iron-nickel alloy as a function of the nickel content. In the region with a nickel percentage between 30% and 40%, this therewith results in a wide invariance of the thermal expansion of the alloy with respect to a temperature change.

It may be provided that the printing roller or the impression cylinder is designed for a functional layer having a useable width corresponding to the length of 8 or 9 A4 printed pages or the width of 12 or 13 A4 printed pages. As already stated, the format of an A4 printed page is a standard size for a paper format which was specified in Germany by the DIN in DIN-Standard DIN-476. The German standard served as the basis for the European or international equivalent EN ISO 216, which has, in turn, been adopted in almost all countries. The A4 format corresponds to a page width of 210 mm and a page height of 297 mm.

It may be provided that the printing roller or the impression cylinder has a second hollow cylinder, which is arranged concentrically to the first hollow cylinder made of a fiber-reinforced material and is arranged between the first and second base element. Therefore especially, a simple design of the printing roller or of the impression cylinder is ensured. In addition, the printing roller or the impression cylinder may be designed in terms of its mass and natural frequency in such a way that the natural frequency is considerably above the rotational frequency of the printing roller or of the impression cylinder when the printing press is being operated so that interfering vibrations during printing press operation can be avoided due to a resonance of the natural frequency of the printing roller or of the impression cylinder with the rotational frequency of the printing roller or the impression cylinder. Furthermore, because of the above-mentioned structural characteristics, a stable construction of the printing roller or of the impression cylinder is possible. This second hollow cylinder serves as a common axis for the mutual alignment of the two base elements respectively on a common center line and for absorbing the bearing forces as well as the bending moments resulting therefrom. The natural frequency of the two hollow cylinders must be considered separate from one another and both are preferably selected in such a way that they are above the maximum achievable operating speed.

In doing so, it may be provided in the case of the printing roller or the impression cylinder that the second hollow cylinder is made of a fiber-reinforced material, for example of a glass-fiber-reinforced material like glass-fiber-reinforced plastic or a carbon-fiber-reinforced material like carbon-fiber-reinforced plastic.

Alternatively, it may be provided in the case of the printing roller or the impression cylinder that the second hollow cylinder is made of steel or another metallic alloy.

It may be provided that the printing roller or the impression cylinder has internal bearings, wherein the base elements are made of at least two concentrically arranged first and second sub-elements, wherein the internal bearings are arranged inside the base elements and wherein the internal bearings are used for rotatable support of the first sub-elements with respect to the second sub-elements of the base elements. This results in an especially compact arrangement.

It may be provided in the case of the printing roller or the impression cylinder that the functional layer and/or the intermediate layer extend at least in a second partial region of the base elements beyond the base elements, wherein, in this second partial region of the base elements, the functional layer and/or the intermediate layer are directly adjacent to the base elements. Therefore, in particular any joint that may be present between the first hollow cylinder and the base elements may be covered and thereby be protected from external influences so that, for example, the penetration of water or ink into the joint may be prevented. Moreover, this may prevent any possible air inclusions at the joint (butt joint between the base element and hollow cylinder) from exerting negative effects during the vulcanization of the gumming such as blistering, for example, that leads to the destruction of the gumming/functional layer.

It may be provided in the case of the printing roller or the impression cylinder that the functional layer has a contouring with decreasing layer thickness in the edge region of the useable width of the functional layer.

It may be provided in the case of the printing roller or the impression cylinder that the contouring of the functional layer is arranged in the region of the base elements and the contouring in the edge region of the useable width of the functional layer is configured such that the layer thickness of the functional layer decreases continuously from a useful layer thickness to a protective layer thickness. Therefore, any joint that may be present in the region of the base elements may be covered in particular in a simple manner and thereby be protected from external influences so that, for example, the penetration of water or ink into the joint may be prevented.

In particular, it may be provided in the case of the printing roller or the impression cylinder that the functional layer with the protective layer thickness extends to the edge of the base elements.

The invention also relates to a printing unit of a printing press, comprising:
at least one printing couple with impression cylinders and at least one inking couple,
wherein the printing couple is designed with a useable width corresponding to the length of 8 A4 printed pages or the width of 12 A4 printed pages,
wherein at least one impression cylinder has a useable circumferential surface corresponding to the size of 96 vertical or horizontal A4 printed pages, and
wherein at least one printing roller of the inking couple and/or at least one impression cylinder of the printing couple are configured according to one or more of the technical characteristics cited in this document.

In addition, the inking couple in this case may also include a dampening unit.

The invention relates further to a printing unit of a printing press, comprising:
at least one printing couple with impression cylinders and at least one inking couple,
wherein the printing couple is designed with a useable width corresponding to the length of 9 A4 printed pages or the width of 13 A4 printed pages,
wherein at least one impression cylinder has a useable circumferential surface corresponding to the size of 104 vertical or horizontal A4 printed pages, and
wherein at least one printing roller of the inking couple and/or at least one impression cylinder of the printing couple are configured according to one or more of the technical characteristics cited in this document.

In addition, the inking couple in this case may also include a dampening unit.

It may be provided, in the case of the printing unit, that the center axes of the impression cylinders of at least one of the printing couples are arranged on a straight line. This results in an especially stable arrangement, in particular through the mutual support of the cylinders and a reduced tendency to vibrate, because moments of torque that are exerted can be compensated for at least partially. In addition, a simple and compact design is produced.

Alternatively, it may be provided in the case of the printing unit that the center axes of a first pair of impression cylinders and the center axes of a second pair of impression cylinders of at least one of the printing couples are arranged on parallel straight lines.

Special exemplary embodiments of the present invention will be described hereinafter with reference to FIGS. 1 through 7.

### BRIEF DESCRIPTION OF THE DRAWINGS

FIG. 1 illustrates exemplary embodiments of printing units of a printing press;

FIG. 2 illustrates impression cylinders for a printing unit according to FIG. 1;

FIG. 3 illustrates alternative impression cylinders for a printing unit according to FIG. 1;

FIG. 4 shows an exemplary embodiment of a printing roller or an impression cylinder;

FIG. 5 shows an alternative exemplary embodiment of a printing roller or an impression cylinder;

FIG. 6 shows an alternative exemplary embodiment of a printing roller or an impression cylinder; and

FIG. 7 shows a coefficient of thermal expansion α of an iron-nickel alloy as a function of nickel content.

### DETAILED DESCRIPTION OF THE DRAWINGS

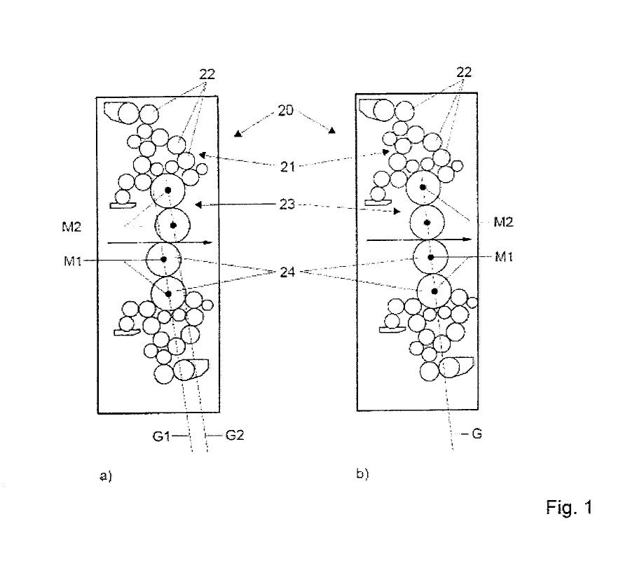

FIGS. 1a) and 1b) each show a printing unit 20 of a printing press, comprising a printing couple 23 with impression cylinders 24 and an inking couple 21 for each impression cylinder pair that is made up of a plate cylinder and a transfer cylinder.

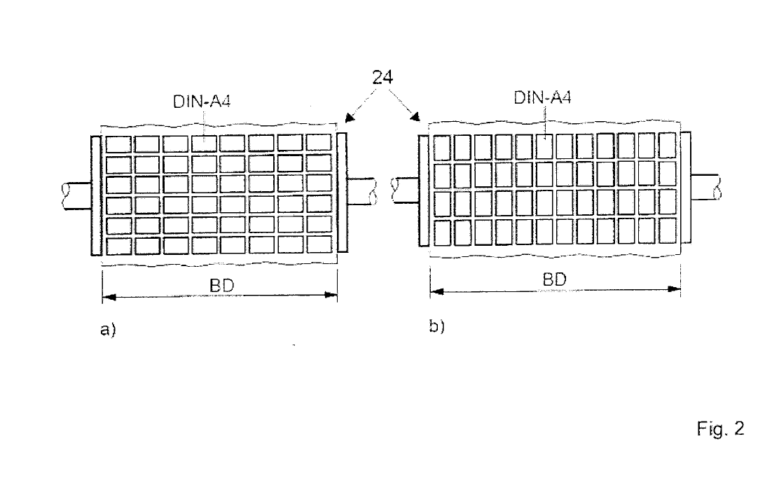

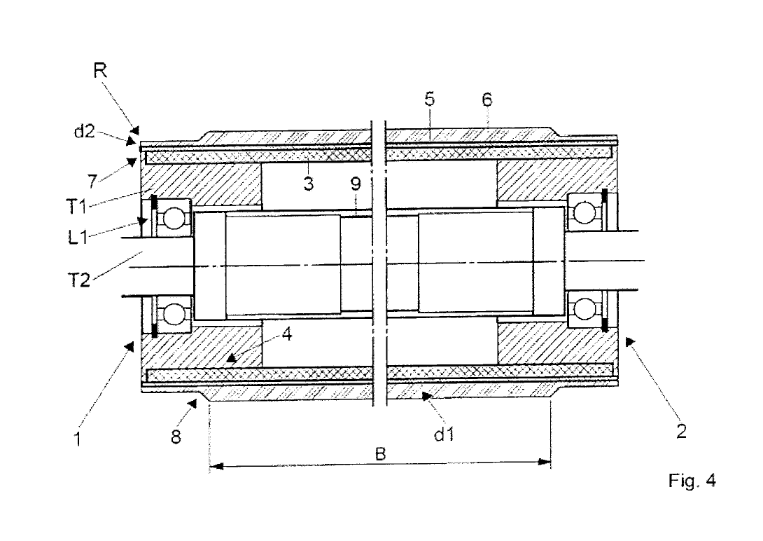

The printing couple 23, in this case, may be designed with a useable width BD, as shown in FIG. 2, which corresponds to the length of 8 A4 printed pages or the width of 12 A4 printed pages (the printed pages are respectively identified as “DIN-A4” in FIG. 2). At least one impression cylinder 24 has a useable circumferential surface corresponding to the size of 96 vertical or horizontal A4 printed pages. At least one printing roller 22 of the inking couple 21 and/or at least one impression cylinder 24 of the printing couple 23 are configured in this case according to one of FIGS. 4 through 6.

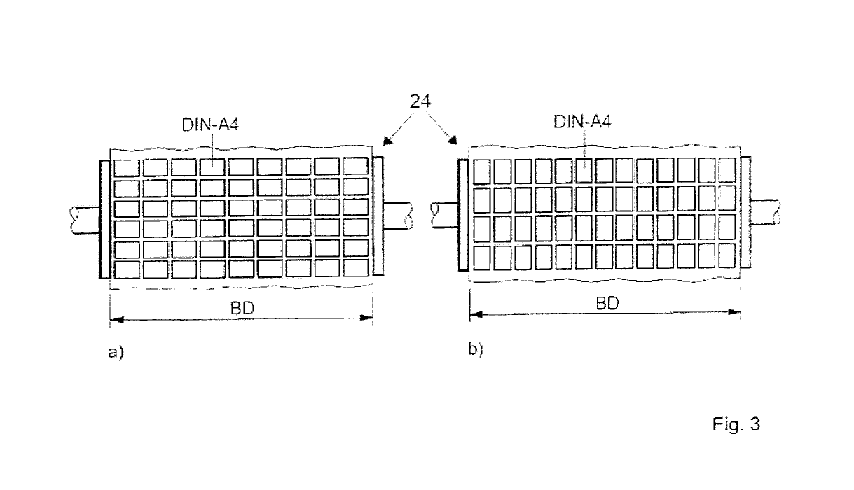

The printing couple 23 may also be designed with a useable width BD, as shown in FIG. 3, which corresponds to the length of 9 A4 printed pages or the width of 13 A4 printed pages (the printed pages are respectively designated as “DIN-A4” in FIG. 3). At least one impression cylinder 24 has a useable circumferential surface corresponding to the size of 104 vertical or 108 horizontal A4 printed pages.

At least one printing roller 22 of the inking couple 21 and/or at least one impression cylinder 24 of the printing couple 23 are configured in this case according to one of FIGS. 4 through 6.

Alternatively, the impression cylinders 24 may also have a circumference corresponding to the width of 4 DIN A4 pages. A double printing unit equipped with such impression cylinders 24 is able to print 64 DIN A4 pages with one revolution of the cylinder.

Because a printed product cannot be cut to its desired format during the production process until after the paper has actually been printed, a projecting edge is preferably provided when several pages are arranged on an impression cylinder. In other words, in the case of a printed product in DIN A4 format (height times width=297 times 210 millimeters), which is arranged, for example, 13 times side-by-side width-wise on an impression cylinder, a useable width of 13 times 220 millimeters, i.e., 2860 millimeters, is yielded for the impression cylinder. This corresponds to a preferred projection, on both sides, of 5 millimeters. Of course, other projection lengths are also possible. This applies analogously in the circumferential direction.

It is provided in the case of the printing unit 20 in FIG. 1b) that the center axes M1, M2 of the impression cylinders 24 of the printing couple 23 are arranged on a straight line G. This results in an especially stable arrangement, in particular through the mutual support of the impression cylinders 24 and a reduced tendency to vibrate, because moments of torque that are exerted can be compensated for at least partially. Thus, straight arrangements with very long impression cylinders 24 can be stabilized additionally and in a simple manner. Furthermore, a simple and compact design is produced.

It is provided in the case of the printing unit 20 in FIG. 1a) that the center axes M1 of the lower pair of impression cylinders 24 and the center axes M2 of the upper pair of impression cylinders 24 of the printing couple 23 are arranged on parallel straight lines G1, G2.

FIGS. 4 through 6 depict alternative exemplary embodiments of printing rollers or also of impression cylinders of a printing press.

Thus, FIGS. 4, 5 and 6 each depict an alternative design of a printing roller 22 or of an impression cylinder 24 of a printing press, comprising a first and a second base element 1, 2 and a first hollow cylinder 3 made of a fiber-reinforced material arranged between the first and the second base element, wherein the base elements 1, 2 are made of a solid, metallic material. The first hollow cylinder 3 made of a fiber-reinforced material extends at least in a first partial region 4 of the base elements 1, 2 beyond the base elements 1, 2.

During printing operation, a functional layer 6 is arranged or can be arranged above the first hollow cylinder 3 made of a fiber-reinforced material. The functional layer 6 may thus be connected to the first hollow cylinder either detachably or permanently (integrally bonded). In this case, it may be a rubber layer, a blanket, a rubber tube, a blanket with a carrier plate or even a metal printing plate. Instead of a homogeneous rubber layer, a sandwich layer of several plies of rubber (if applicable, even porous rubber) and woven fabric may be provided. The printing roller 22 or the impression cylinder 24 is designed for a functional layer 6 having a useable width B corresponding to the length of 8 or 9 A4 printed pages or the width of 12 or 13 A4 printed pages.

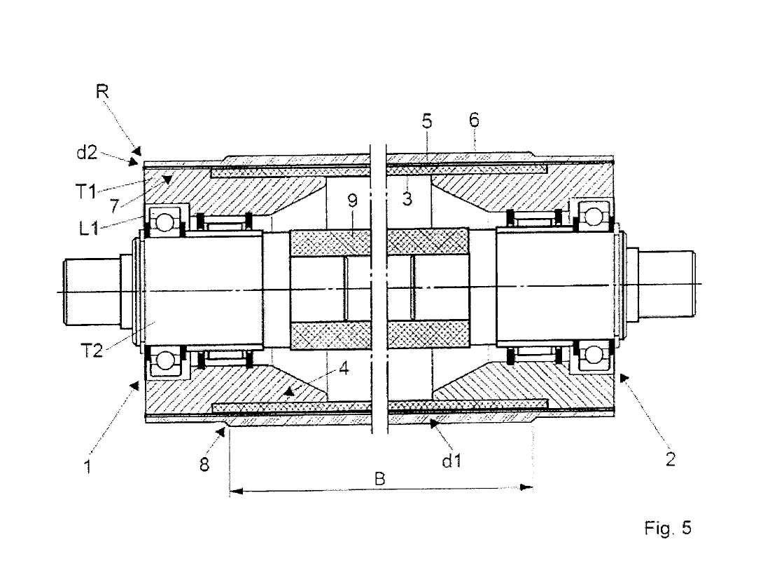

In the embodiments according to FIGS. 4 and 5, an intermediate layer 5 is respectively arranged above the first hollow cylinder 3 made of a fiber-reinforced material, said intermediate layer being made of a different material than the functional layer 6 and the first hollow cylinder 3 made of a fiber-reinforced material.

The intermediate layer 5 contains dyes (for example, color pigments embedded in the layer), which give the intermediate layer 5 a different color than that of the functional layer 6 arranged above it or to be arranged above it. If the functional layer 6 has to be removed for further use of the printing roller 22 or of the impression cylinder 24, then it is easy for one to identify on the basis of the different color whether the functional layer 6 has been removed completely. If removal of the functional layer 6 is carried out, for example, with material-removing tools like a lathe, then one is easily able to identify from the emerging different color when a complete removal of the functional layer has occurred so that the process of material removal can be terminated. At the same time, the intermediate layer 5 prevents the tools from damaging the fiber-reinforced hollow cylinder 3 arranged beneath it.

In the case of the embodiments in FIGS. 4 and 5, the functional layer 6 and the intermediate layer 5 have a larger width than the first hollow cylinder 3 made of a fiber-reinforced material. The functional layer 6 and/or the intermediate layer 5 extend in this case beyond the first hollow cylinder 3 made of a fiber-reinforced material at least partially also beyond the base elements 1, 2, especially beyond the first sub-element T1 of the base elements 1, 2. Therefore, the joint between the first hollow cylinder 3 and the base elements 1, 2 or the sub-element T1 may be covered and thereby be protected from external influences so that, for example, the penetration of water or ink into the joint may be prevented. Moreover, this may prevent any possible air inclusions at the joint (butt joint between the base element and hollow cylinder) from exerting negative effects during vulcanization of the gumming such as blistering, for example, that leads to the destruction of the gumming/functional layer.

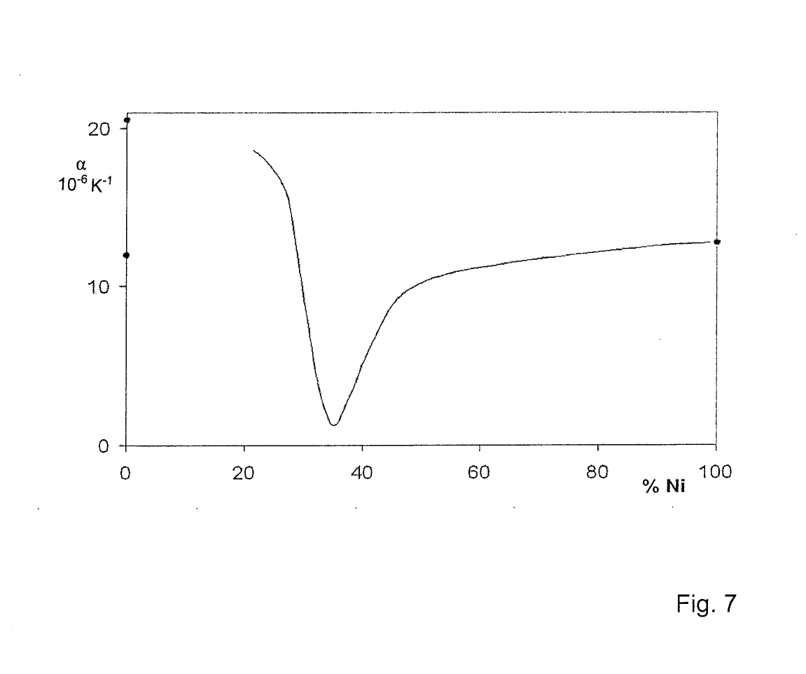

The base elements 1, 2 (at least however the first sub-elements T1 of the base elements) are made of a metallic material which has a coefficient of thermal expansion α less than 10*10⁻⁶ K⁻¹, in particular a coefficient of thermal expansion α less than 5*10⁻⁶ in addition, in particular, a coefficient of thermal expansion α less than 2.5*10⁻⁶ K⁻¹. In this case, in particular a metallic material made of a metal alloy with a nickel percentage between 30% and 40% may be used. Especially applicable in this case are iron-nickel alloys, which might also include cobalt as another element, but this is not absolutely necessary. FIG. 7 depicts the coefficient of thermal expansion α of an iron-nickel alloy as a function of the nickel content. In the region with a nickel percentage between 30% and 40%, this therewith results in a wide invariance of the thermal expansion of the alloy with respect to a temperature change.

The printing roller 22 or the impression cylinder 24 according to FIG. 4, 5, or 6 is designed for a functional layer 6 having a useable width B corresponding to the length of 8 or 9 A4 printed pages or the width of 12 or 13 A4 printed pages.

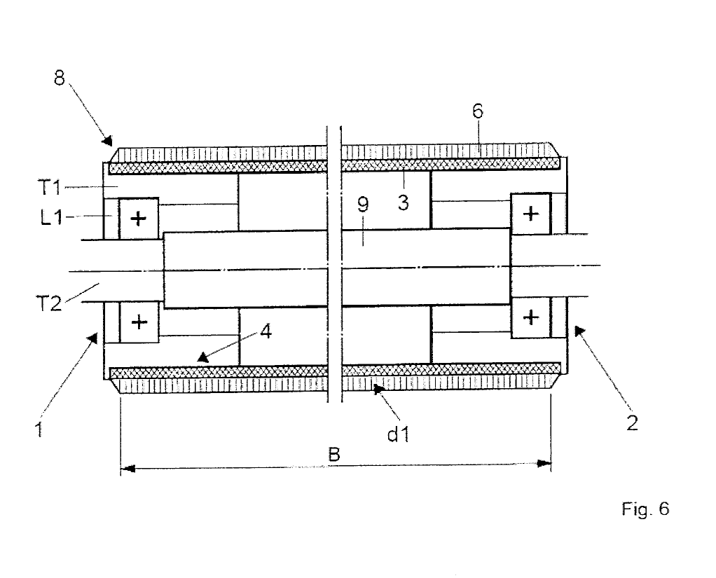

The printing roller 22 or the impression cylinder 24 has a second hollow cylinder 9, which is arranged concentrically to the first hollow cylinder 3 made of fiber-reinforced material and is arranged between the first and second base element 1, 2. It is provided in the case of the embodiment in FIG. 5 that the second hollow cylinder is made of a fiber-reinforced material. It is provided in the embodiments according to FIGS. 4 and 6 that the second hollow cylinder 9 is made of steel.

The printing roller 22 or the impression cylinder 24 in FIGS. 4 through 6, respectively, has internal bearings L1, L2, wherein the base elements 1, 2 are made of at least two concentrically arranged first and second sub-elements T1, T2, the internal bearings L1, L2 are arranged inside the base elements 1, 2 and the internal bearings L1, L2 are used for rotatable support of the first sub-elements T1 relative to the second sub-elements T2 of the base elements 1, 2. According to FIGS. 4 and 6, only one internal bearing L1 is provided. According to FIG. 5, two internal bearings L1, L2 are provided, wherein the second internal bearing L2 may also be configured as a needle bearing in order to permit a movement of the printing roller 22 or of the impression cylinder 24 in the axial direction—for example, an oscillating reciprocating movement.

The first hollow cylinder 3 is respectively connected in a rotationally fixed manner with the first sub-elements T1 of the base elements 1, 2, and the second hollow cylinder 9 is connected in a rotationally fixed manner with the second sub-elements T2 of the base elements 1, 2. In the embodiments in FIGS. 4 and 5, the functional layer 6 and the intermediate layer 5 extend in the second partial region 7 of the base elements 1, 2 beyond the base elements 1, 2, wherein, in this second partial region 7 of the base elements 1, 2, the intermediate layer 5 is directly adjacent to the base elements 1, 2. If this intermediate layer 5 were not provided, then the functional layer 6 would be directly adjacent to the base elements 1, 2 in this second partial region 7 of the base elements 1, 2.

The functional layer 6 respectively has a contouring 8 with decreasing layer thickness in the edge region of the useable width of the functional layer 6. It is respectively provided that the contouring 8 of the functional layer 6 is arranged in the region of the base elements 1, 2. It is provided in the case of the embodiments in FIGS. 4 and 5 that the contouring 8 in the edge region of the useable width of the functional layer 6 is configured such that the layer thickness of the functional layer 6 decreases continuously from a useful layer thickness d1 to a protective layer thickness d2, wherein the functional layer 6 with the protective layer thickness d2 extends to the edge R of the base elements 1, 2.

1. A printing roller or impression cylinder of a printing press, comprising:
a first and a second base element (1, 2); and
a first hollow cylinder (3) made of a fiber-reinforced material arranged between the first and second base element (1, 2);
wherein the base elements (1, 2) are made of a solid metallic material;
wherein the first hollow cylinder (3) made of a fiber-reinforced material extends at least in a first partial region (4) of the base elements (1, 2) beyond the base elements (1, 2);
wherein, during printing operation, a functional layer (6) is arranged or can be arranged above the first hollow cylinder (3) made of a fiber-reinforced material;
and wherein the printing roller or the impression cylinder is designed for a functional layer (6) having a useable width (B) corresponding to the height of 8 or 9 A4 printed pages or the width of 12 or 13 A4 printed pages.

2. The printing roller or impression cylinder according to claim 1,
wherein an intermediate layer (5) is arranged above the first hollow cylinder (3) made of a fiber-reinforced material, said intermediate layer being made of a different material than the functional layer (6) and the first hollow cylinder (3) made of a fiber-reinforced material.

3. The printing roller or impression cylinder according to claim 2,
wherein the intermediate layer (5) contains dyes, which give the intermediate layer (5) a different color than that of the functional layer (6) arranged above it or to be arranged above it.

4. The printing roller or impression cylinder according to claim 2,
wherein the functional layer (6) and/or the intermediate layer (5) have a larger width than the first hollow cylinder (3) made of a fiber-reinforced material.

5. The printing roller or impression cylinder according to claim 4,
wherein the functional layer (6) and/or the intermediate layer (5) extend beyond the first hollow cylinder (3) made of a fiber-reinforced material also at least partially beyond the base elements (1, 2).

6. A printing roller or impression cylinder of a printing press, comprising:
a first and second base element (1, 2); and
a first hollow cylinder (3) made of a fiber-reinforced material arranged between the first and second base element (1, 2);
wherein the base elements (1, 2) are made of a solid material;
wherein the first hollow cylinder (3) made of a fiber-reinforced material extends at least in a first partial region (4) of the base elements (1, 2) beyond the base elements (1, 2);
wherein an intermediate layer (5) is arranged above the first hollow cylinder (3) made of a fiber-reinforced material, said intermediate layer being made of a different material than the functional layer (6) and the first hollow cylinder (3) made of a fiber-reinforced material;
wherein, during printing operation, the functional layer (6) is arranged or can be arranged above the intermediate layer (5);
and wherein the functional layer (6) and/or the intermediate layer (5) have a larger width than the first hollow cylinder (3) made of a fiber-reinforced material.

7. A printing roller or impression cylinder of a printing press, comprising:
a first and second base element (1, 2); and
a first hollow cylinder (3) made of a fiber-reinforced material arranged between the first and second base element (1, 2);
wherein the first hollow cylinder (3) made of a fiber-reinforced material extends at least in a first partial region (4) of the base elements (1, 2) beyond the base elements (1, 2);
wherein an intermediate layer (5) is arranged above the first hollow cylinder (3) made of a fiber-reinforced material, said intermediate layer being made of a different material than the first hollow cylinder (3) made of a fiber-reinforced material, or, during printing operation, a functional layer (6) is arranged or can be arranged above the first hollow cylinder (3) made of a fiber-reinforced material, said functional layer being made of a different material than the first hollow cylinder (3) made of a fiber-reinforced material;
wherein the functional layer (6) and/or the intermediate layer (5) have a larger width than the first hollow cylinder (3) made of a fiber-reinforced material;
and wherein the base elements (1, 2) are made at least partially of a material whose coefficient of thermal expansion α is less than 10*10⁻⁶ K⁻¹.

8. The printing roller or impression cylinder according to claim 1, wherein the coefficient of thermal expansion of at least the first hollow cylinder (3) corresponds approximately to the coefficient of thermal expansion of a sub-element (T1) of the base element (1, 2).

9. The printing roller or impression cylinder according to claim 1,
wherein the base elements (1, 2) are made at least partially of a metallic material, in particular of a metallic alloy with a nickel percentage between 30% and 40%.

10. The printing roller or impression cylinder according to claim 6,
wherein the printing roller (22) or the impression cylinder (24) is designed for a functional layer (6) having a useable width corresponding to the length of 8 or 9 A4 printed pages or the width of 12 or 13 A4 printed pages.

11. The printing roller or impression cylinder according to claim 1,
wherein the printing roller (22) or the impression cylinder (24) has a second hollow cylinder (9), which is arranged concentrically to the first hollow cylinder (3) made of a fiber-reinforced material and is arranged between the first and second base element (1, 2).

12. The printing roller or impression cylinder according to claim 11,
wherein the second hollow cylinder (9) is made of a fiber-reinforced material.

13. The printing roller or impression cylinder according to claim 11,
wherein the second hollow cylinder (9) is made of steel.

14. The printing roller or impression cylinder according to claim 1,
wherein the printing roller (22) or the impression cylinder (24) has internal bearings (L1, L2),
wherein the base elements (1, 2) are made of at least two concentrically arranged first and second sub-elements (T1, T2),
wherein the internal bearings (L1, L2) are arranged inside the base elements (1, 2) and
wherein the internal bearings (L1, L2) are used for rotatable support of the first sub-elements (T1) with respect to the second sub-elements (T2) of the base elements (1, 2).

15. The printing roller or impression cylinder according to claim 14,
wherein the first hollow cylinder (3) is connected in a rotationally fixed manner with the first sub-elements (T1) of the base elements (1, 2), and the second hollow cylinder (9) that may be present is connected in a rotationally fixed manner with the second sub-elements (T2) of the base elements (1, 2).

16. The printing roller or impression cylinder according to claim 1,
wherein the functional layer (6) and/or the intermediate layer (5) extend(s) at least in a second partial region (7) of the base elements (1, 2) beyond the base elements (1, 2),
wherein, in this second partial region (7) of the base elements (1, 2), the functional layer (6) and/or the intermediate layer (5) are directly adjacent to the base elements (1, 2).

17. The printing roller or impression cylinder according to claim 1,
wherein the functional layer (6) has a contouring (8) with decreasing layer thickness in the edge region of the useable width (B) of the functional layer (6).

18. The printing roller or impression cylinder according to claim 17,
wherein the contouring (8) of the functional layer (6) is arranged in the region of the base elements (1, 2), and the contouring (8) in the edge region of the useable width (B) of the functional layer (6) is configured such that the layer thickness of the functional layer (6) decreases continuously from a useful layer thickness (d1) to a protective layer thickness (d2).

19. The printing roller or impression cylinder according to claim 18,
wherein the functional layer (6) with the protective layer thickness (d2) extends to the edge (R) of the base elements (1, 2).

20. A printing unit (20) of a printing press, comprising:
at least one printing couple (23) with impression cylinders (24) and at least one inking couple (21) with printing rollers (22);
wherein the printing couple (23) is designed with a useable width (BD) corresponding to the height of 8 A4 printed pages or the width of 12 A4 printed pages;
wherein at least one impression cylinder (24) has a useable circumferential surface corresponding to the size of 96 vertical or horizontal A4 printed pages;
and wherein at least one printing roller (22) of the inking couple (21) and/or at least one impression cylinder (24) of the printing couple (23) is/are configured according to claim 1.

21. A printing unit (20) of a printing press, comprising:
at least one printing couple (23) with impression cylinders (24) and at least one inking couple (21) with printing rollers (22);
wherein the printing couple (23) is designed with a useable width (BD) corresponding to the length of 9 A4 printed pages or the width of 13 A4 printed pages;
wherein at least one impression cylinder (24) has a useable circumferential surface corresponding to the size of 104 vertical or 108 horizontal A4 printed pages; and
and wherein at least one printing roller (22) of the inking couple (21) and/or at least one impression cylinder (24) of the printing couple (23) are configured according to claim 1.

22. The printing unit of a printing press according to claim 20,
wherein the center axes (M1, M2) of the impression cylinders (24) of at least one of the printing couples (23) are arranged on a straight line (G).

23. The printing unit of a printing press according to claim 20,
wherein the center axes (M1) of a first pair of impression cylinders (24) and the center axes (M2) of a second pair of impression cylinders (24) of at least one of the printing couples (23) are arranged on parallel straight lines (G1, G2).
